(19) United States
(12) Patent Application Publication
(10) Pub. No.: US 2014/0074345 A1
(43) Pub. Date: Mar. 13, 2014

(54) Systems, Apparatuses, Methods, Circuits and Associated Computer Executable Code for Monitoring and Assessing Vehicle Health

(71) Applicants: Chanan Gabay, Kfar Saba (IL); Yaron Agi, Zur Igal (IL)

(72) Inventors: Chanan Gabay, Kfar Saba (IL); Yaron Agi, Zur Igal (IL)

(21) Appl. No.: 13/612,914

(22) Filed: Sep. 13, 2012

(51) Int. Cl. G06F 7/00

(52) U.S. Cl. 701/31.4; 701/29.1; 701/33.9; 701/34.4; 701/33.4

(57) ABSTRACT

The present invention includes methods, circuits, sensors, apparatus, controllers and associated computer executable code and data for monitoring assessing and predicting a mechanical, structural and/or electrical condition (hereinafter collectively referred to as: “Vehicle Health” or “VH”) of a motor vehicle, such as a car, truck, motor cycle, etc. According to some embodiments, there may be provided a vehicle health monitoring, assessing and predicting system (VHMS) functionally associated with a vehicle and adapted to monitor, assess and/or predict a VH of the vehicle. A VHMS may be comprised of a set of VH sensors adapted to collect data relating to the VH of the vehicle and processing circuitry adapted to analyze the collected data and determine and/or predict the VH of the vehicle, possibly in real time.

### FIELD OF THE INVENTION

The present invention is generally related to the field of Vehicle Maintenance. More specifically, the present invention is related to systems, apparatuses, methods, circuits and associated computer executable code for monitoring and assessing vehicle health.

### BACKGROUND

Integrated Vehicle Health Management (IVHM) as a concept grew out of popular aviation maintenance methods. It was a natural next step from condition based maintenance. As sensors improved and our understanding of the systems concerned grew it became possible to not just detect failure but also to predict it. Faults causing unscheduled maintenance come with a high cost and can make the vehicle unsafe. The high unit cost & high maintenance cost of aircraft & spacecraft made any advance in maintenance methods very attractive.

NASA was one of the first organizations to use the name IVHM to describe how they wanted to approach maintenance of spacecraft in the future. They created NASA-CR-192656, in 1992 with the assistance of the General Research Corporation and the Orbital Technologies Corporation. This was a goals & objectives document in which they discussed the technology and maintenance concepts that they believed would be necessary to enhance safety while reducing maintenance costs in their next generation vehicles. Many companies since then have become interested in IVHM and body of literature has increased substantially. There are now IVHM solutions for many different types of vehicle from the JSF to commercial haulage vehicles.

One of the key milestones in the creation of IVHM for aircraft was the series of ARINC standards that enabled different manufacturers to create equipment that would work together and be able to send diagnostic data from the aircraft to the maintenance organization on the ground. ACARS is frequently used to communicate maintenance and operational data between the flight crew and the ground crew. This has led to concepts which have been adopted in IVHM.

Another milestone was the creation of health and usage monitoring systems (HUMS) for helicopters operating in support of the Oil rigs in the North Sea. This is key concept that usage data can be used to assist maintenance planning FOQA or Flight Data systems are similar to HUMS as they monitor the vehicle usage. They are useful for IVHM in the same way as they allow the usage of the vehicle to be thoroughly understood which aids in the design of future vehicles. It also allows excessive loads and usage to be identified and corrected. For example if an aircraft was experiencing frequent heavy landings the maintenance schedule for the undercarriage could be changed to ensure that they are not wearing to fast under the increased load. The load carried by the aircraft could be lessened in future or operators could be given additional training to improve the quality of the landings.

The growing nature of this field led Boeing to set up an IVHM centre with Cranfield University in 2008 to act as a world leading research hub. The IVHM centre has since then offered the worlds first IVHM Msc course and hosts several PhD students researching the application of IVHM to different fields.

IVHM is concerned not just with the current condition of the vehicle but also with health across its whole life cycle. IVHM examines the vehicle health against the vehicle usage data and within the context of similar information of other vehicles within the fleet. In use, vehicles display unique usage characteristics and also some characteristics common across the fleet. Where usage data and system health data is available these can be analyzed to identify these characteristics. This is useful in the identification of problems unique to one vehicle as well as identifying trends in vehicle degradation across the entire fleet.

IVHM is a concept for the complete maintenance life cycle of an aircraft (or machine plant installation). It makes extensive use of embedded sensors and self-monitoring equipment combined with prognostics and diagnostic reasoning. In the case of an aircraft it is typical for there to be a data acquisition module on-board and a diagnostic unit. Some aircrafts can transfer selected data back to base while in use through various RF systems. Whenever the aircraft is at base the data is also transferred to a set of maintenance computers that also process that data for a deeper understanding of the true health of the aircraft. The usage of the aircraft can also be matched to the degradation of parts and improve the prognostics prediction accuracy.

The remaining useful life is used to plan replacement or repair of the part at some convenient time prior to failure. The inconvenience of taking the aircraft out of service is balanced against the cost of unscheduled maintenance to ensure that the part is replaced at the optimum point prior to failure. This process has been compared to the process of choosing when to buy financial options as the cost of scheduled maintenance must be balanced against the risk of failure and the cost of unscheduled maintenance.

This differs from Condition-based maintenance (CBM) where the part is replaced once it has failed or once a threshold is passed. This often involves taking an aircraft out of service at an inconvenient time when it could be generating revenue. It is preferable to use an IVHM approach to replace it at the most convenient time. This allows the reduction in waste component life caused by replacing the part too early and also reducing cost incurred by unscheduled maintenance. This is possible due to the increased prognostic distance provided by an IVHM solution. There are many technologies that are used in IVHM. The field itself is still growing and many techniques are still being added to the body of knowledge.

In automobiles and other personal vehicles, however, IVHM is as of yet virtually non-existent. Although the modern vehicle contains many vehicle health related sensors, these sensors are used to detect immanent failure of a particular component they are associated with. General analysis of sensor readings and of overall vehicle health is not performed, nor is prediction of future failure. Moreover, many parameters relating to vehicle health which could be measured are not and many sensor types which could be useful for these purposes are still absent from the modern car. Real time analysis of vehicle health is also relatively primitive considering the technology now available. Accordingly, new and improved vehicle monitoring systems are needed.

### SUMMARY

The present invention includes methods, circuits, sensors, apparatus, controllers and associated computer executable code and data for monitoring assessing and predicting a mechanical, structural and/or electrical condition (hereinafter collectively referred to as: “Vehicle Health” or “VH”) of a motor vehicle, such as a car, truck, motor cycle, etc. According to some embodiments, there may be provided a vehicle health monitoring, assessing and predicting system (VHMS) including a set of sensors, residing in and around a vehicle (hereinafter collectively referred to as: “Vehicle Health Sensors”), one or more sensor group controllers/processors, a vehicle health central processing unit (VHCPU) for receiving and processing signals generated by the sensors, a data storage, a user display, a user interface, a communication module and/or a remote vehicle health monitoring system central server.

According to some embodiments, each VH sensor or group of VH sensors may measure and forward to the VHCPU one or more parameters relating to the operation and/or health of the vehicle and its components. According to further embodiments, a group of VH sensors, which may include a group of a particular type of VH sensors distributed in different locations throughout the vehicle or a group of different types of sensors positioned in a common area, may measure and forward its measurements to a sensor group controller/processor, which may aggregate and/or analyze the measurements of the group/sensor and forward the results of its aggregation/analysis to the VHCPU. A VHCPU may, continuously, intermittently and/or upon instancement, assess a VH of the vehicle based on the received parameters. In the event that the VHCPU determines, based on a given set of parameters received from the VH sensors and/or sensor group controllers/processors, that the VH of the vehicle is flawed or below a defined threshold, the VHCPU may: (1) issue a warning to a user of the vehicle, (2) initiate automatic corrective action if possible, (3) initiate automatic preventive action if possible (4) communicate the vehicle condition and/or sensed parameters to an external server/unit; and/or (5) initiate emergency action (e.g. deactivate the vehicle or one of its components). The VHCPU may determine that the VH of the vehicle is flawed or below a defined threshold when a specific sensed parameter is below/above a defined threshold and/or when a set of two or more parameters are each below/above a defined threshold, i.e. a VH may be assessed based on parameter thresholds on a parameter by parameter basis and/or based on thresholds defined for combinations of parameters. For example, a vehicle may be assessed as being in poor VH if the oil pressure is below x and/or if the oil pressure is below y while the operating temperature is above z.

According to further embodiments of the present invention, a VHCPU may collect data received from the VH sensors over time and may extrapolate from the data operating parameters relating to the typical operation of the specific vehicle it is associated with. The VHCPU may dynamically maintain a vehicle profile including “normal” operating parameters of the specific vehicle, which “normal” parameters may subsequently be employed as a comparison/base-line in order to assess the VH of the vehicle and/or to dynamically modify thresholds and operating parameters of the VHMS system. Similarly, when a malfunction of a component of the vehicle occurs, measured operating parameters of the vehicle leading up to the malfunction may be analyzed in order to determine specific parameters which may have indicated, prior to the malfunction, that the malfunction is forthcoming. The results of this analysis may later be used as a comparison in order to determine the vehicles VH in the future and/or to dynamically modify thresholds and operating parameters of the VHMS system. For example, if it is found that prior to engine breakdown there were 10% fluctuations in oil pressure, future fluctuations in oil pressure of 10% or more may be interpreted to indicate upcoming engine failure. In other words, a particular vehicle's measurement history and “normal” measurements may be used as a comparison for determining the vehicles VH at a particular moment and/or to dynamically modify thresholds and operating parameters of the VHMS system. Furthermore, different parameters relating to a vehicle's mechanical condition and operation may be compared and analyzed in conjunction in order to determine optimal and/or preferred operating parameters for the specific vehicle (e.g. an oil pressure which is correlated to the highest mileage per liter of fuel may be determined to be preferred to an oil pressure which produces a lower mileage per liter of fuel or an oil pressure which is correlated to the lowest vibrations in the engine may be preferred, etc.)

According to further embodiments, a VHCPU may factor into its calculations parameters relating to the operation of the vehicle, such as mileage, latest tune up, average speed and rpm, etc. According to further embodiments, a VHCPU may factor into its calculations environmental and circumstantial parameters relevant to the operation of the mechanical elements of the vehicle (e.g. outside temperature, humidity, air quality, etc.)

According to further embodiments, a VHCPU may determine if an assessed vehicle VH poses a safety risk and/or a degree of the risk and in the event that risk is determined, may: (1) issue a warning to a user of the vehicle, (2) initiate automatic corrective action if possible, (3) initiate automatic preventive action if possible, (4) communicate the vehicle condition and/or sensed parameters to an external server/unit, and/or (5) initiate emergency action (e.g. deactivate the vehicle or one of its components).

According to yet further embodiments of the present invention, data may be collected from multiple VHMS systems at a vehicle health monitoring system central server or servers and/or within one or more VHMS. Such data may be sent between VHMS's and/or to the central server or servers from the vehicles via any known communication technology, (e.g. via a cellular network). According to some embodiments, a VHCPU may include or be functionally associated with an appropriate communication module for communicating with one or more central servers and/or other VHMS. Such a central server or servers may analyze data received from multiple VHCPU's to determine typical operating parameters of vehicles, specific types of vehicles, specific models of vehicles, specific engine types, vehicles operating under particular conditions, vehicles of a particular age/mileage, etc. and update dynamic thresholds and operating parameters of relevant VHMS systems in light of the results of the analysis. Similarly, when a malfunction of a component of a vehicle having a VHMS system occurs, measured operating parameters of the vehicle leading up to the malfunction may be analyzed in order to determine specific parameters which may have indicated, prior to the malfunction, that the malfunction is forthcoming. The results of this analysis may later be used as a comparison in order to determine thresholds and operating parameters of other VHMS systems, possibly installed in a similar vehicle or a vehicle operating under similar conditions. In other words, data collected from one vehicle or many vehicles (i.e. statistical data) which experienced a failure may be used to determine parameters indicative of an upcoming problem in another vehicle. For example, if it is found that in 90% of cases, prior to engine breakdown in a Toyota, there were 10% fluctuations in oil pressure, whereas in 90% of cases, prior to engine breakdown in a Honda, there were 15% fluctuations in oil pressure all VHMS systems installed in Toyotas may determine future fluctuations in oil pressure of 10% or more as indicative of upcoming engine failure, while all VHMS systems installed in Hondas may determine only future fluctuations in oil pressure of 15% or more as indicative of upcoming engine failure. In other words, other vehicle's measurement histories and “normal” measurements may be used as a comparison for determining a particular vehicles mechanical condition at a particular moment.

According to some embodiments, a VHCPU may perform its assessments of vehicle VH based on one or more sets of desired operational parameters and associated thresholds for the vehicle pre-programmed into the VHMS system. According to further embodiments, initial desired parameters and associated thresholds may be defined by a calibration/normalization process including measurement of initial operating parameters to be used as a base line for future comparison. According to yet further embodiments, initial desired parameters and associated thresholds may be defined by a combination of pre-defined thresholds and a calibration process specific to the vehicle in question.

According to further embodiments, the desired operational parameters and associated thresholds for the vehicle may be dynamically modified over time based on the data monitored by the VHCPU and the associated analyses, parameters relating to the operation of the vehicle, such as mileage, latest tune up, average speed and rpm, etc, desired parameters determined by a centralized server or servers, which may be based on data collected from other vehicles, statistical analysis and/or updates provided by a proprietor of the system.

According to some embodiments, a VHMS system may include a set of VH sensors and/or groups of VH sensors, residing in and around the vehicle, for measuring parameters relating to the VH and operation of the vehicle. The set of VH sensors may include any sensor for measuring a parameter relating to the VH and/or operation of the vehicle, including but not limited to:
a. Acoustic sensors for detecting noises/sounds emitting from an engine of the vehicle and/or any other mechanical component of the vehicle (e.g. brakes, driveshaft, etc.). Audio sensors may detect noises resulting from friction, movement of vehicle components, etc. Based on the nature, frequency, location and amplitude of noises emitting from the engine and other mechanical components, a VHCPU may determine the condition of vehicle components and/or their interaction with other components;
b. Flowing substance/Optical sensors for measuring the transparency/contamination of liquids used by the vehicle (e.g. engine oil) by means of imaging or light penetration, magnetic tests and/or filtering. According to some embodiments, an examined liquid may be subjected to a magnetic field prior to traveling through an optical sensor in order to extract/arrange Ferrite components;
c. Vibration and/or piezoelectric sensors for measuring vibrations of mechanical components of the vehicle;
d. Radiation sensors for measuring electromagnetic radiation emitted from vehicle components;
e. Thermal sensors for measuring temperatures of one or more mechanical components/liquids/gases of the vehicle;
f. Magnetic sensors for measuring magnetic fields created by electric currents and/or moving parts in a vehicle;
g. Energy sensors for measuring energy consumption/efficiency of the vehicle. For example, the electric energy drawn from a vehicle battery and/or engine, the fuel consumption in relation to mechanical energy generated by the engine, the energy created by the brakes, etc;
h. Environmental sensors for measuring relevant environmental parameters (e.g. outside temperature, humidity, air quality, etc);
i. Electric impedance/resistance sensors for measuring the electric impedance/resistance of particular components of a vehicle (which may indicate the thickness and/or operating temperature of a component);
j. Pressure sensors for measuring liquid or gas pressure within vehicle systems;
k. Air-borne Particle Sensors for detecting the presence and/or concentration of certain particles in the air, associated with certain fluids and/or gases used in the vehicle, may be distributed in the vehicle.
l. Distance sensors for measuring the distance between components of a vehicle (e.g. for measuring the distance between wheels of a vehicle);
m. Accelerometers for measuring acceleration/deceleration of the vehicle and/or vehicle components in one or more directions; and/or
n. Any other vehicle health related sensor known today or to be devised in the future.

According to some embodiments, a VHMS system may include a Human machine interface (possibly including a graphic user interface) for receiving input from a user of the vehicle and communicating to the user data relating to the VH of the vehicle and/or the VHMS system, e.g. for displaying to the user parameters relating to the VH of the vehicle, vehicle condition assessments, and/or vehicle mechanical condition warnings, for displaying to a user information relating to the mechanical condition of the vehicle (e.g. where to fill oil if it is determined that the vehicle oil pressure is low) and so on.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1: is an illustration of an exemplary VHMS installed in an automobile, in accordance with some embodiments of the present invention. It should be understood that FIG. 1 is solely intended to demonstrate the present invention and as such includes only demonstrative components (e.g. only a portion of the VH sensors) may be illustrated;

FIGS. 2A-2C: are illustrations of exemplary VHMS installed in automobiles, in which two possible VHMS architectures are presented, all in accordance with some embodiments of the present invention, wherein:

FIG. 2A—exemplifies some embodiments in which VH sensors are connected directly to a VHCPU;

FIG. 2B—exemplifies some embodiments in which some VH sensors are connected to controllers, which in turn are connected to a VHCPU; and

FIG. 2C—illustrates communication between multiple VHMS and a VHMS central server;

It should be understood that FIGS. 2A-2C are solely intended to demonstrate the present invention and as such include only demonstrative components (e.g. only a portion of the VH sensors) may be illustrated;

FIGS. 3A-3B: are illustrations of exemplary VH sensor distribution in an automobile, in accordance with some embodiments of the present invention, wherein:

FIG. 3A—illustrates an exemplary distribution of Vibration sensors in an automobile; and

FIG. 3B—illustrates an exemplary distribution of Acoustic sensors in an automobile;

It should be understood that FIGS. 3A-3B illustrate exemplary distributions of two types of sensors in an automobile (Vibration and Acoustic) as examples. Clearly, many embodiments of VHMS include many more sensor types distributed in the Vehicle;

FIGS. 4A-4C: are block diagrams presenting exemplary VHMS architectures, in accordance with some embodiments of the present invention, wherein:

FIG. 4A—exemplifies some embodiments in which some VH sensors are connected to controllers, which in turn are connected to a VHCPU, wherein sensors are grouped by type;

FIG. 4B—exemplifies some embodiments in which VH sensors are connected directly to a VHCPU; and

FIG. 4C—exemplifies some embodiments in which some VH sensors are connected to controllers, which in turn are connected to a VHCPU, wherein sensors are grouped by area;

FIGS. 5A-5C: are flowcharts of exemplary steps of operation of a VHMS, all in accordance with some embodiments of the present invention, wherein:

FIG. 5A—exemplifies ordinary operation of a VHMS, in some embodiments in which some VH sensors are connected to controllers, which in turn are connected to a VHCPU; and

FIG. 5B-exemplifies ordinary operation of a VHMS, in some embodiments in which VH sensors are connected directly to a VHCPU; and

FIG. 5C-exemplifies vehicle health profile creation and maintenance;

FIG. 6: is a schematic illustration of an exemplary oil contamination sensor, in accordance with some embodiments of the present invention.

and

FIGS. 7A-7B: are exemplary graphs of VH parameter behavior according to an exemplary (‘Bathtub’ type) VH behavioral model, all in accordance with some embodiments of the present invention, wherein:

FIG. 7A—presents an exemplary general “bathtub” type graph; and

FIG. 7B—presents an exemplary oil contamination “bathtub” type graph.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term server may refer to a single server or to a functionally associated cluster of servers.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, memory cards (for example SD card), SIM cards, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer, communication device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language or markup language. It will be appreciated that a variety of programming languages or techniques may be used to implement the teachings of the inventions as described herein.

The present invention includes methods, circuits, sensors, apparatus, controllers and associated computer executable code and data for monitoring assessing and predicting a mechanical, structural and/or electrical condition (hereinafter collectively referred to as: “Vehicle Health” or “VH”) of a motor vehicle (internal combustion, electric, gas, hybrid, etc), such as a car, truck, motor cycle, etc. According to some embodiments, there may be provided a vehicle health monitoring, assessing and predicting system (VHMS) functionally associated with a vehicle and adapted to monitor, assess and/or predict a VH of the vehicle. A VHMS may be comprised of a set of VH sensors adapted to collect data relating to the VH of the vehicle and processing circuitry adapted to analyze the collected data and determine and/or predict the VH of the vehicle, possibly in real time. A VHMS may be further adapted to (1) issue a warning to a user of the vehicle when a fault in the VH if the vehicle is determined or predicted, (2) initiate automatic corrective action when a fault in the VH of the vehicle is determined or predicted, (3) initiate automatic preventive action when a fault in the VH of the vehicle is determined or predicted possible (4) communicate the vehicle condition and/or sensed parameters to an external server/unit and/or other VHMS; and/or (5) initiate emergency action (e.g. deactivate the vehicle or one of its components). Furthermore, a VHMS may be adapted to collect data relating to VH, which may then be used for improvement of VHMS and/or for use by other parties associated with VH (e.g. vehicle manufacturers, legislators, regulatory bodies, mechanics, etc.).

### Architecture

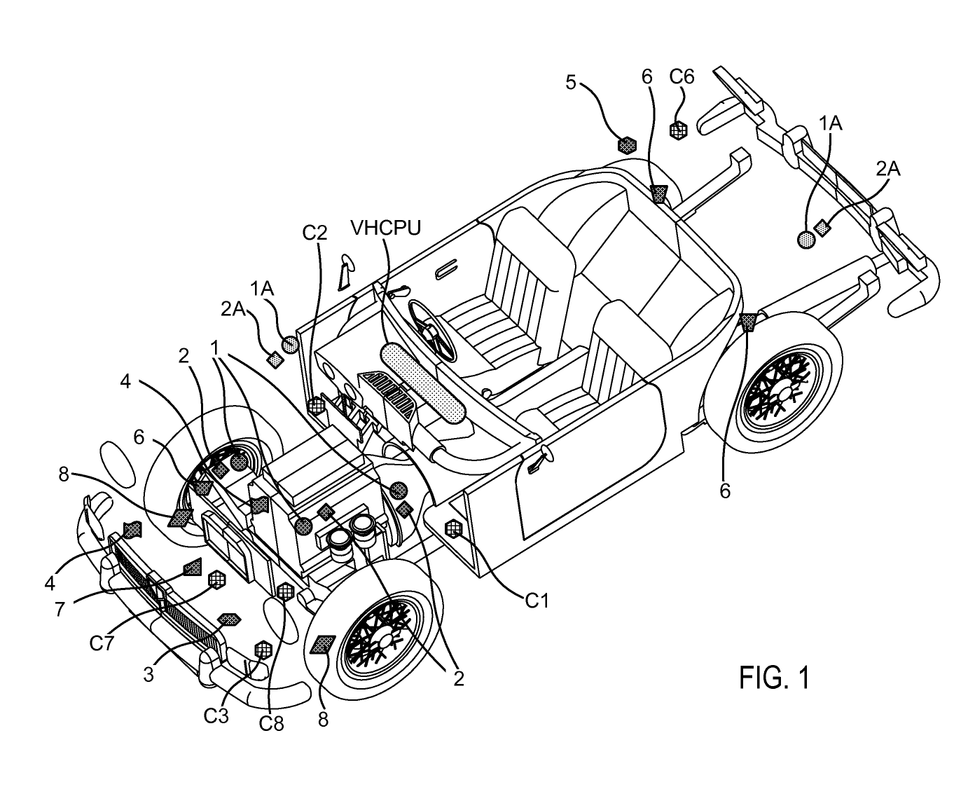

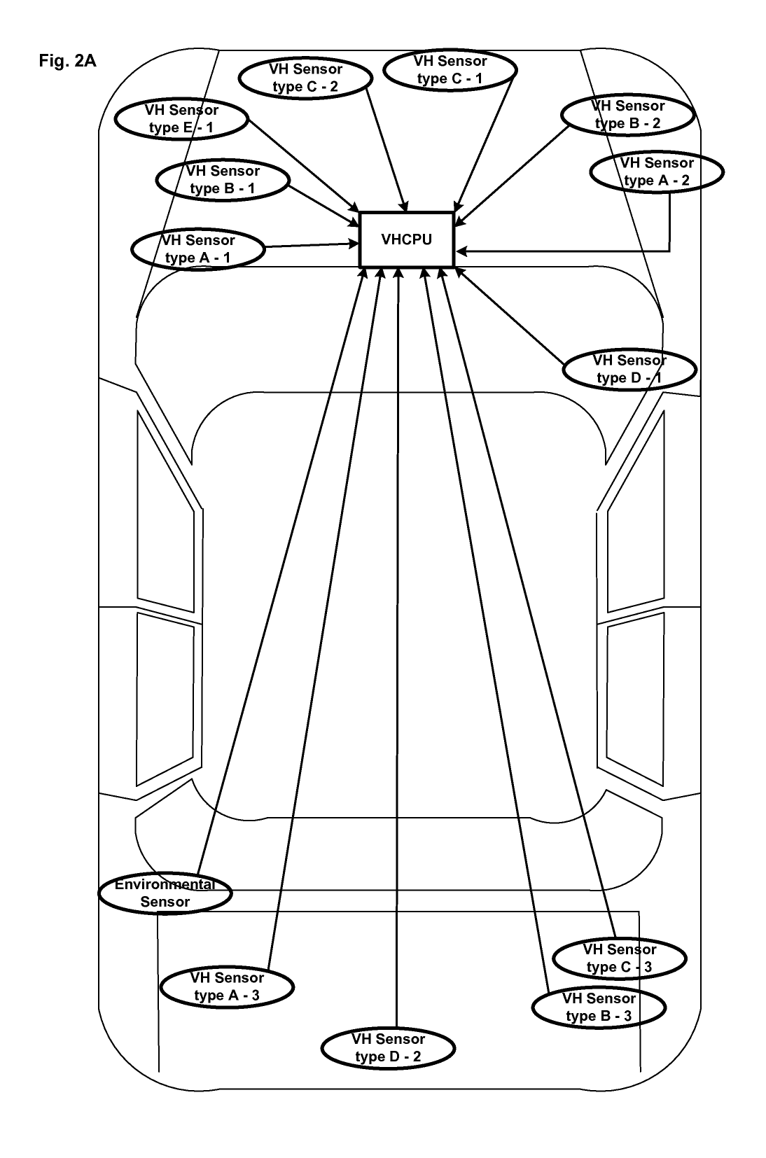

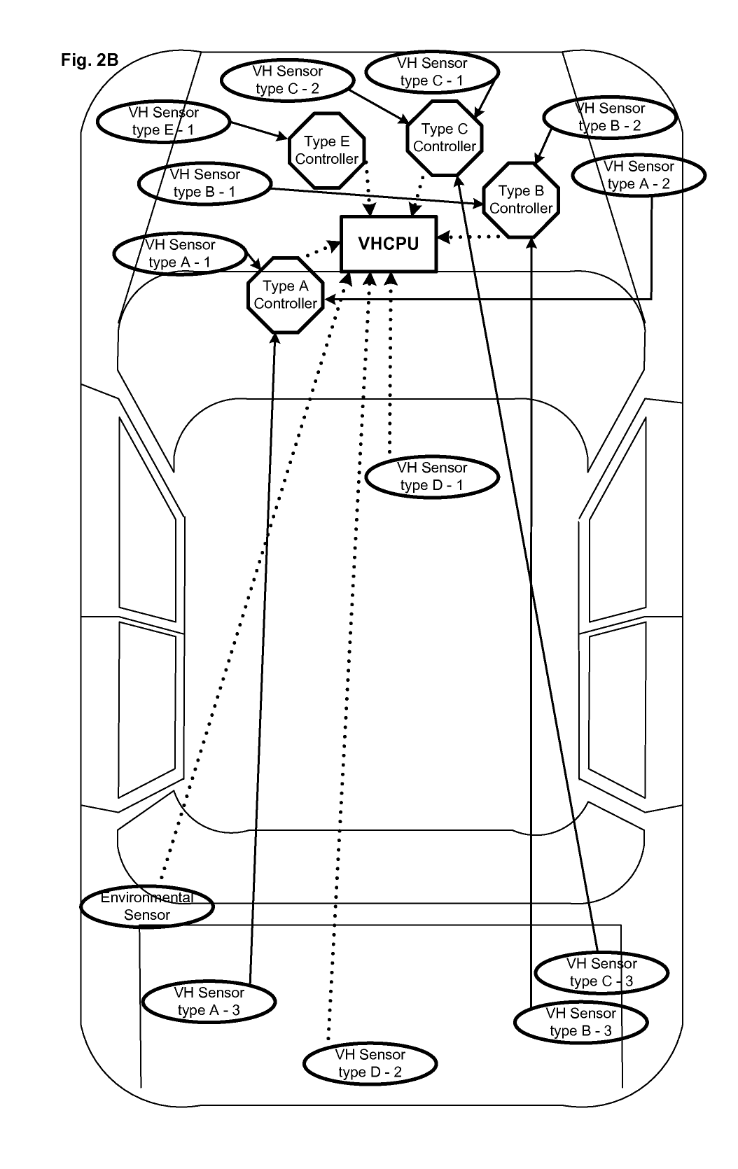

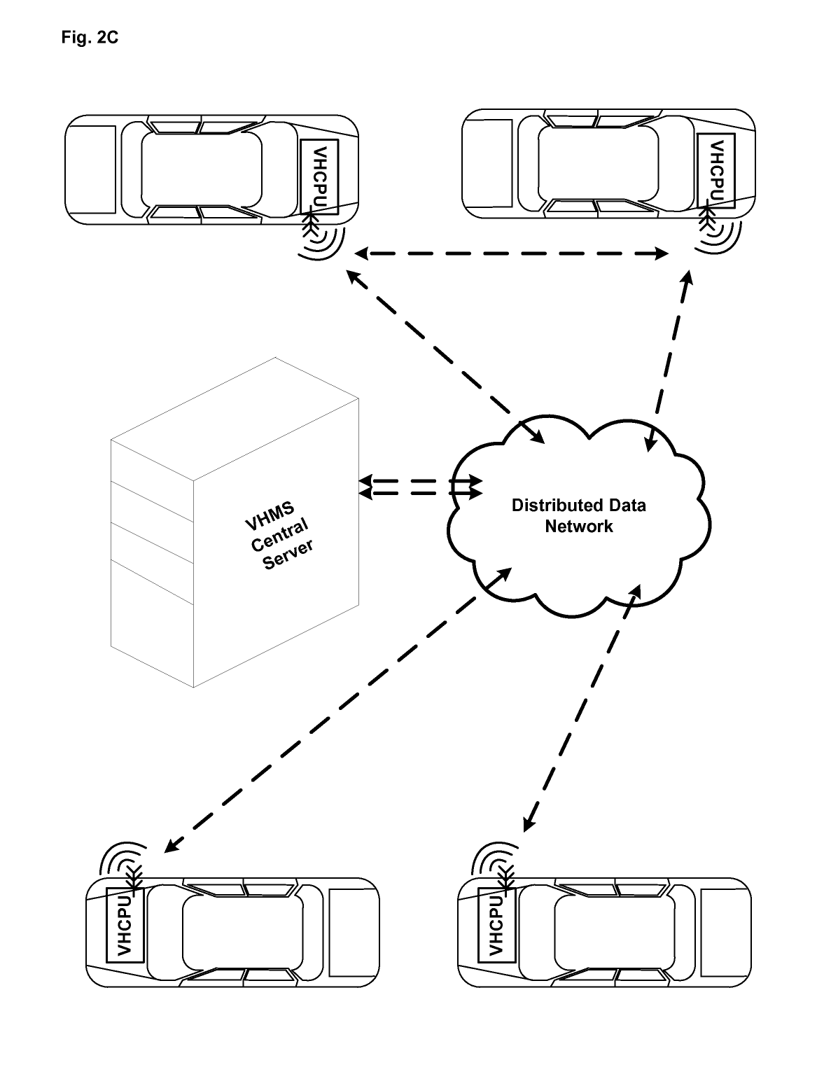

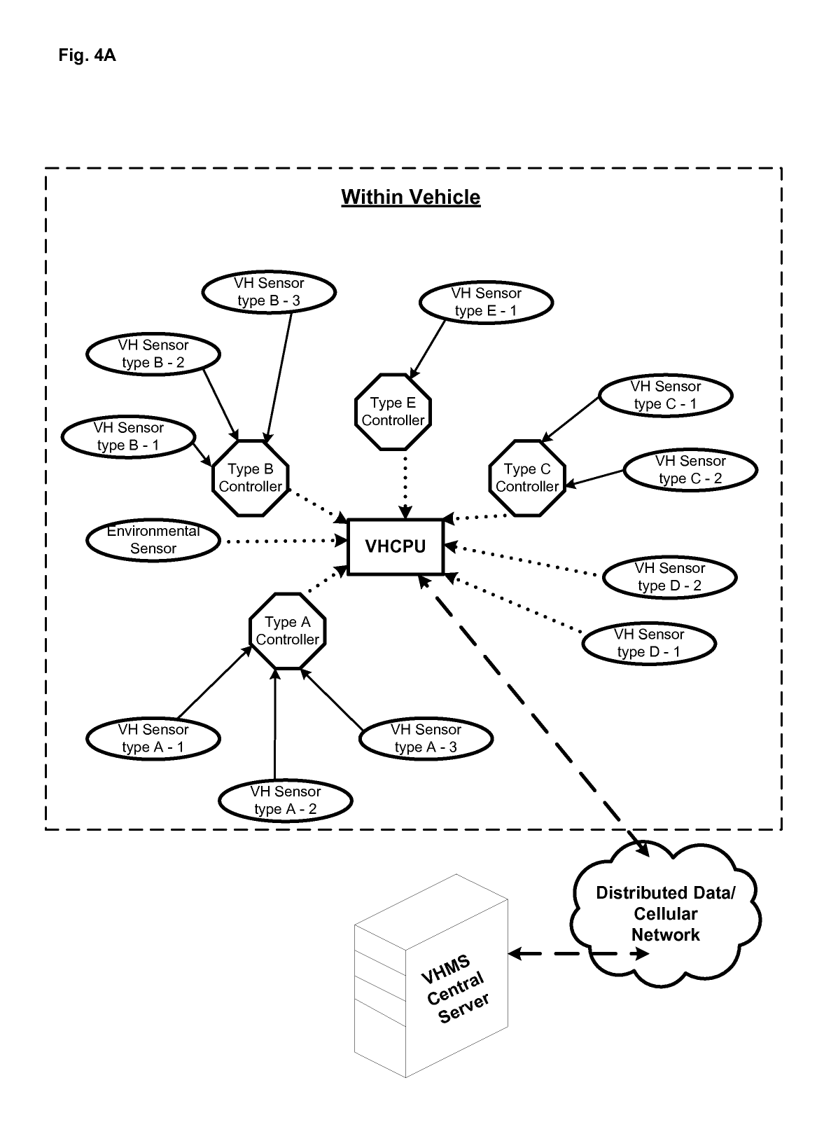

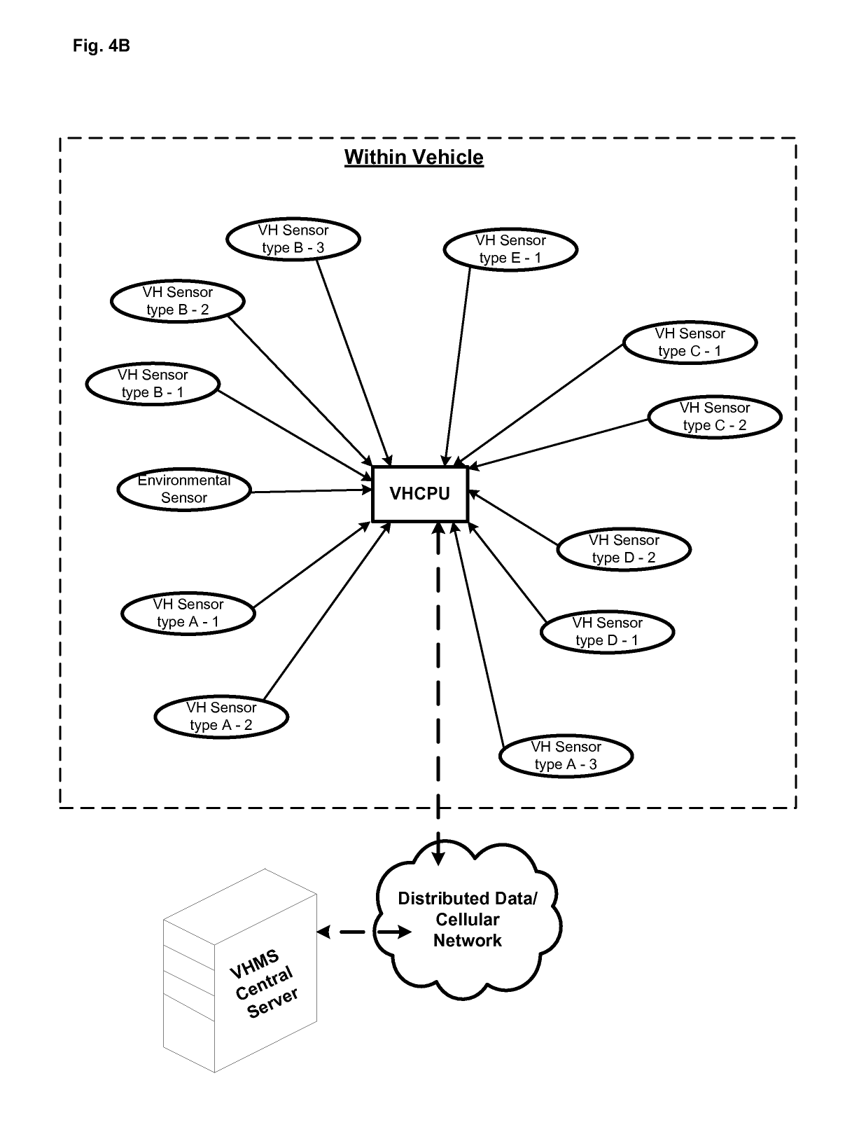

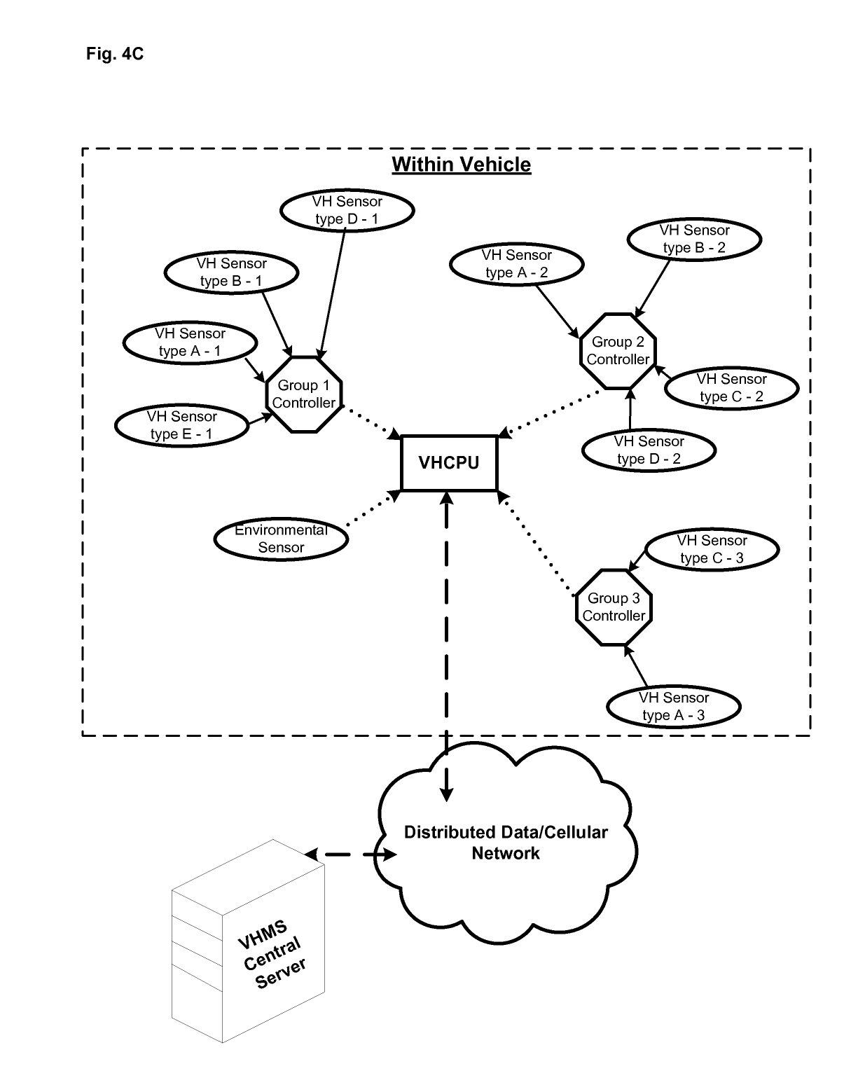

Reference is now made to FIGS. 1-4 which present exemplary illustrations of a VHMS architecture. According to some embodiments, a VHMS may include a set of VH sensors [see FIG. 1] of different types, residing in and around a vehicle. FIG. 1 is an illustration of an exemplary VHMS residing within an exemplary vehicle (the exterior panels of the vehicle have been removed for viewing convenience). In the figure an exemplary VHCPU is represented in an exemplary location. Further are presented exemplary VH sensors (marked 1-8 and 1A-2A), wherein each number represents an exemplary sensor type (e.g. 1—acoustic sensor, 2—vibration sensor, 3—fluid substance sensor, 4—thermostat, 5—environmental sensor, 6—impedance sensor, 7—particle sensor, 8—distance sensor) and the mark A represents an area sensor (e.g. 1A—area acoustic sensor) as further explained below. Furthermore, sensor controllers are presented in FIG. 1 and marked C1-C8. Exemplary communicative connections between the components are presented in FIGS. 2A-2B and 4A-4C, wherein FIGS. 2A and 4B exemplify embodiments in which VH sensors are communicate directly with a VHCPU and FIGS. 2B and 4A exemplify embodiments in which some VH sensors communicate their measurements to a controller which in turn communicates with a VHCPU, all as further described in detail below.

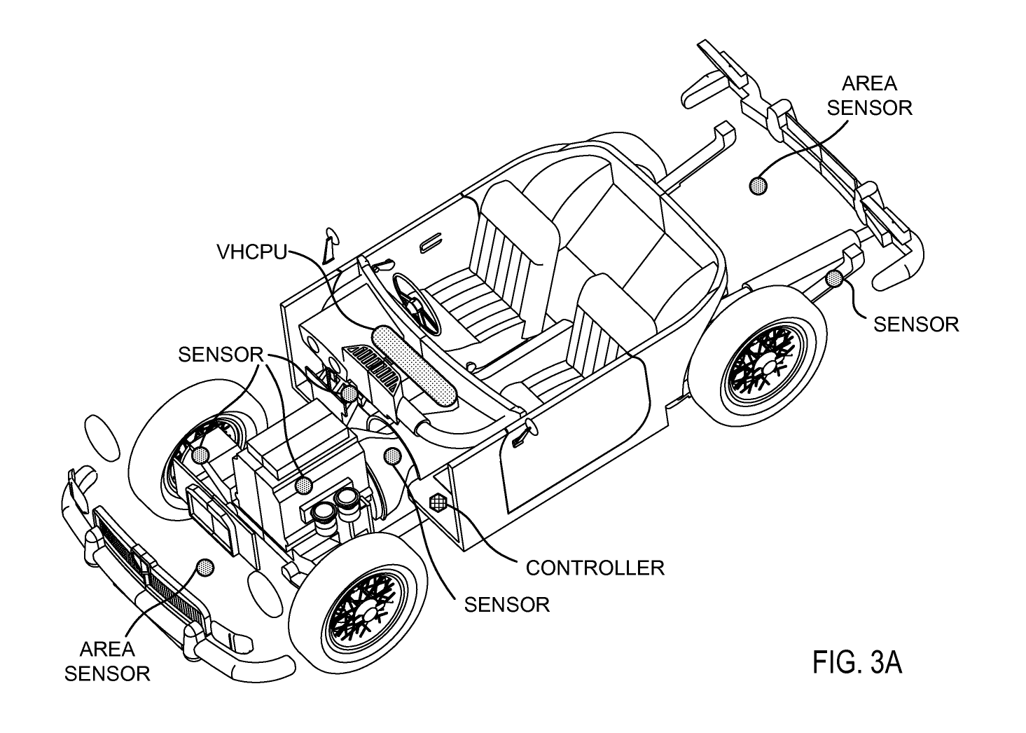

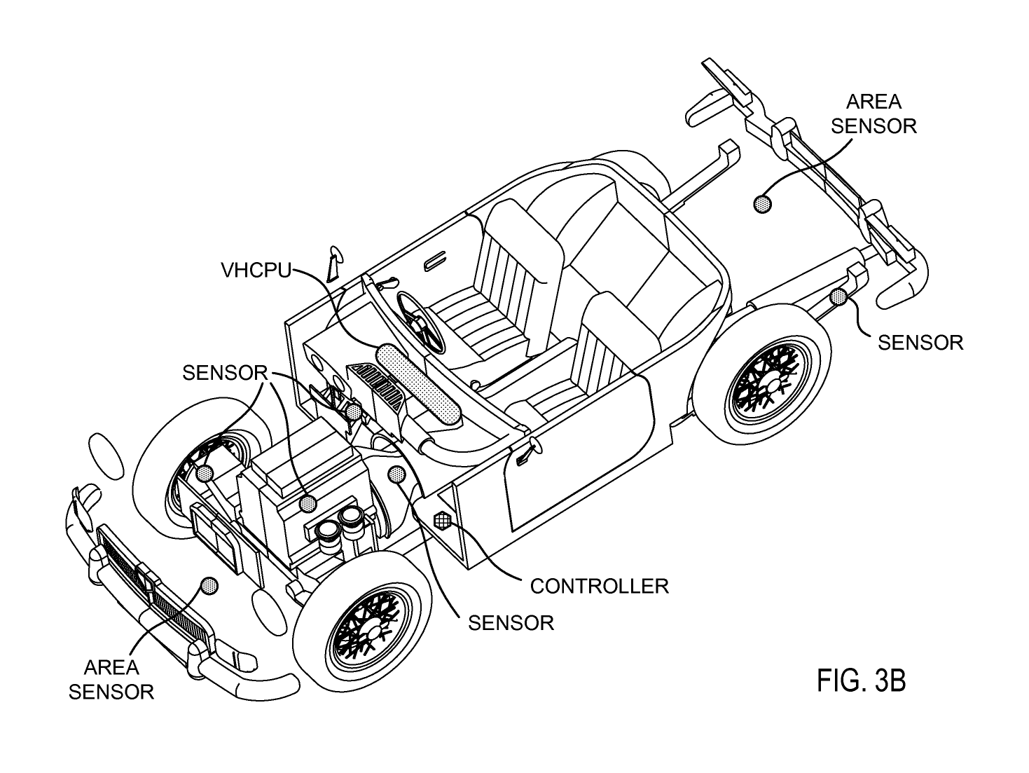

A set of VH sensors of a VHMS may include one or more sensors of a particular type which may form groups of sensors (e.g. a group of vibration sensors) [see FIGS. 2B, 4A & 4C], wherein each of the sensors within a group may measure a particular aspect of VH of a particular component or area of the vehicle. For example, a group of vibration sensors may include one or more vibration sensors which measure vibrations within the engine, one or more vibration sensors which measure vibrations of steering elements and one more vibration sensors which measure vibrations within the braking system [see FIG. 3A]. According to some embodiments, sensors may be grouped by other criteria, for example, by area of the vehicle (e.g. front sensors, side sensors, rear sensors, etc.). In such embodiments, a group of sensors may include sensors of different types (e.g. a front vibration sensor may belong to the same group as a front acoustic sensor) [see FIG. 4C].

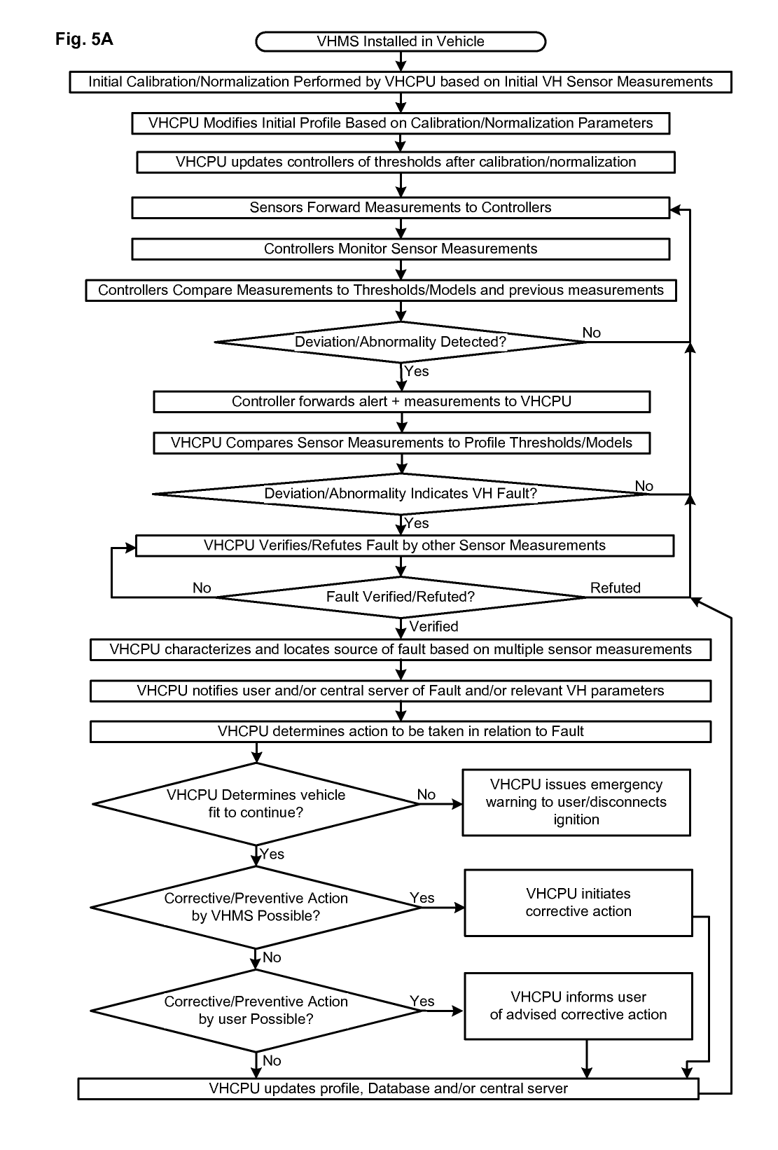

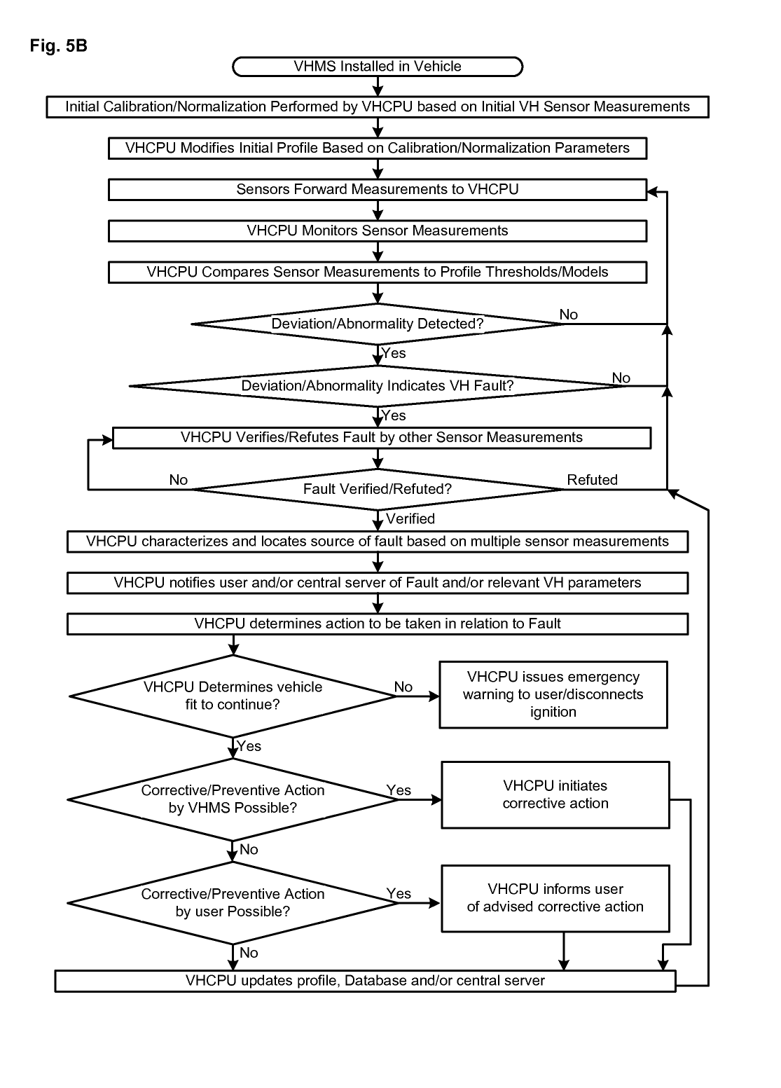

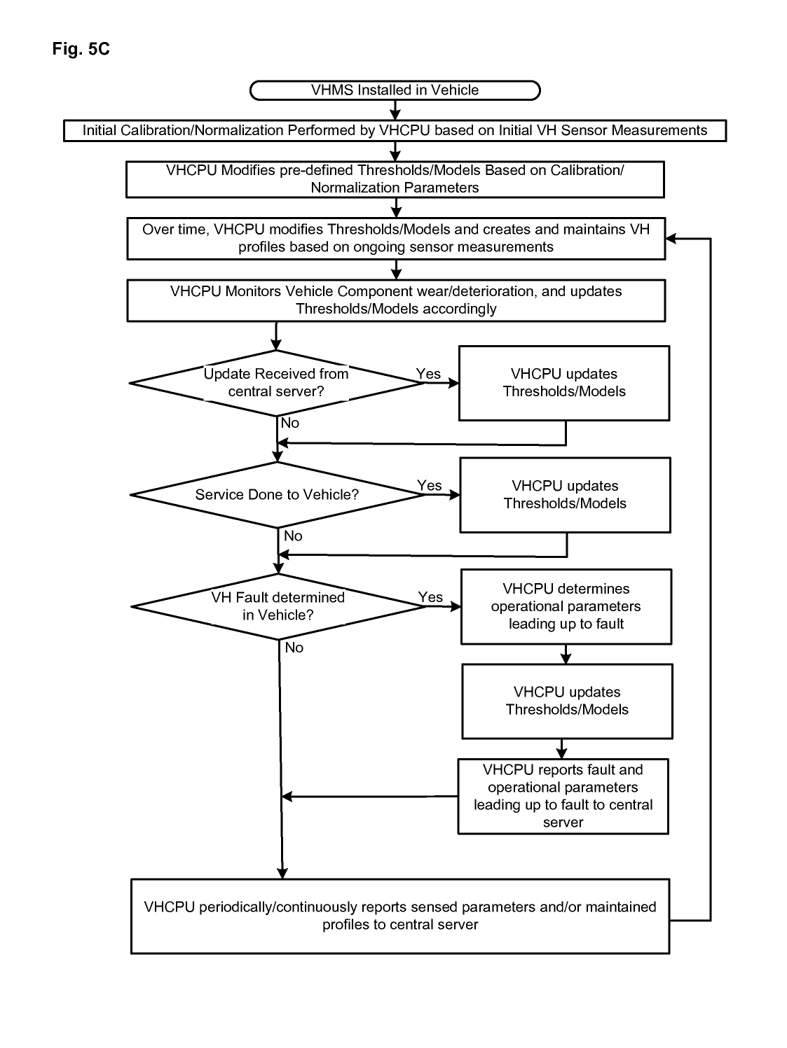

According to some embodiments, each VH sensor may be communicatively coupled to a a vehicle health central processing unit (VHCPU) and forward the results of its measurements to the VHCPU [see FIGS. 2A, 4B & 5B]. According to further embodiments, each VH sensor or group of sensors, may be functionally associated with a controller [marked C in FIG. 1] including processing circuitry for performing analysis of parameters measured by the particular VH sensor or sensors with which it is associated and may in turn be communicatively coupled to the VHCPU and forward to the VHCPU parameters derived from the analysis [see FIGS. 2B, 4C & 5A]. According to yet further embodiments, particular VH sensor or sensor group controllers may only forward to the VHCPU irregular measurements or parameters, i.e. may first determine if an abnormality has been sensed and only then forward the parameters to the VHCPU [see FIG. 5A]. According to further embodiments, VH sensor or sensor group controllers may forward to the VHCPU current and/or average measurements or parameters periodically, upon the occurrence of certain events, upon user command and/or upon request from the VHCPU. It should be understood that a mixture of the above embodiments may be implemented, i.e. some sensors or sensor groups may be communicatively coupled to a VHCPU and send all measurements to the VHCPU whereas others may be functionally associated with a controller for initial analysis of measurement data prior to transmitting VH related data to the VHCPU while yet others only forward measurements upon request and yet others forward their measurements periodically and so on. Communications between the VH sensors, the controllers and the VHCPU may be wired or wireless, according to any known communication technique known today or to be devised in the future. Furthermore, communications between VHMS components may be encrypted.

According to further embodiments, a VHMS may be communicatively coupled to native systems of the vehicle, may receive parameters relating to the VH of the vehicle from them and may factor these parameters in its calculations. For example, a VHMS may be communicatively coupled to a vehicle onboard computer system (OCS) and may receive from the OCS any parameter relating to the operation and VH of the vehicle known to the OCS (e.g. current speed, oil pressure, outside temperature, etc.). A VHMS may further be communicatively coupled to native sensing systems/components of the vehicle and may receive from them measurements they perform. For example, a VHMS may be communicatively coupled to the native oil pressure sensor of the vehicle.

According to some embodiments, group/sensor controllers and/or a VHCPU may react differently when sensing rapid or extreme changes in measured VH related parameters. In such situations (i.e. emergency situations) the VHCPU may issue emergency warnings to a user and/or initiate emergency corrective/preventive actions (e.g. cut the ignition if a rapid drop in oil pressure or a rapid rise in engine temperature is detected). Furthermore, group/sensor controllers sensing rapid or extreme changes in measured VH related parameters may send priority signals to a VHCPU which may be processed prior to normal signals.

According to further embodiments, a VHCPU may include or be functionally associated with a communication module adapted to communicate with a remote vehicle health monitoring system central server [see FIG. 2C] and\or other VHMS installed in other vehicles, possibly via a distributed data network, a cellular network and/or any other communication technology known today or to be devised in the future. A VHCPU may forward to a remote vehicle health monitoring system central server data relating to the VH of the vehicle it is installed in and may receive from the remote vehicle health monitoring system central server updates and operating parameters. A VHCPU may further receive data relating to a particular situation of VH circumstance arising in the vehicle it is associated with. For example, a VHCPU may receive from a remote vehicle health monitoring system central server instructions regarding actions to be taken in response to a particular VH situation. According to further embodiments, portions of the analysis described herein as being performed by a VHCPU may be performed remotely at a remote vehicle health monitoring system central server.

According to some embodiments, a VHMS may further comprise one or more data storage units, functionally associated with the VHCPU or controllers, for storing measured VH parameters (i.e. a measurement history), results of measured VH parameter analysis (i.e. a VH history of the vehicle) and/or operating parameters of the VHMS. A VHMS may also comprise one or more displays and/or a user interface for displaying to the user warnings, VH status and related parameters, informative data (e.g. the closest gas station or mechanic), and/or any other data relating to the operation of the VHMS. A VHMS user interface may also provide for a user to input data and/or operational commands to the VHMS. A VHMS user interface may further provide for a user to interact with a remote vehicle health monitoring system central server and/or other VHMS users.

### VH Sensors

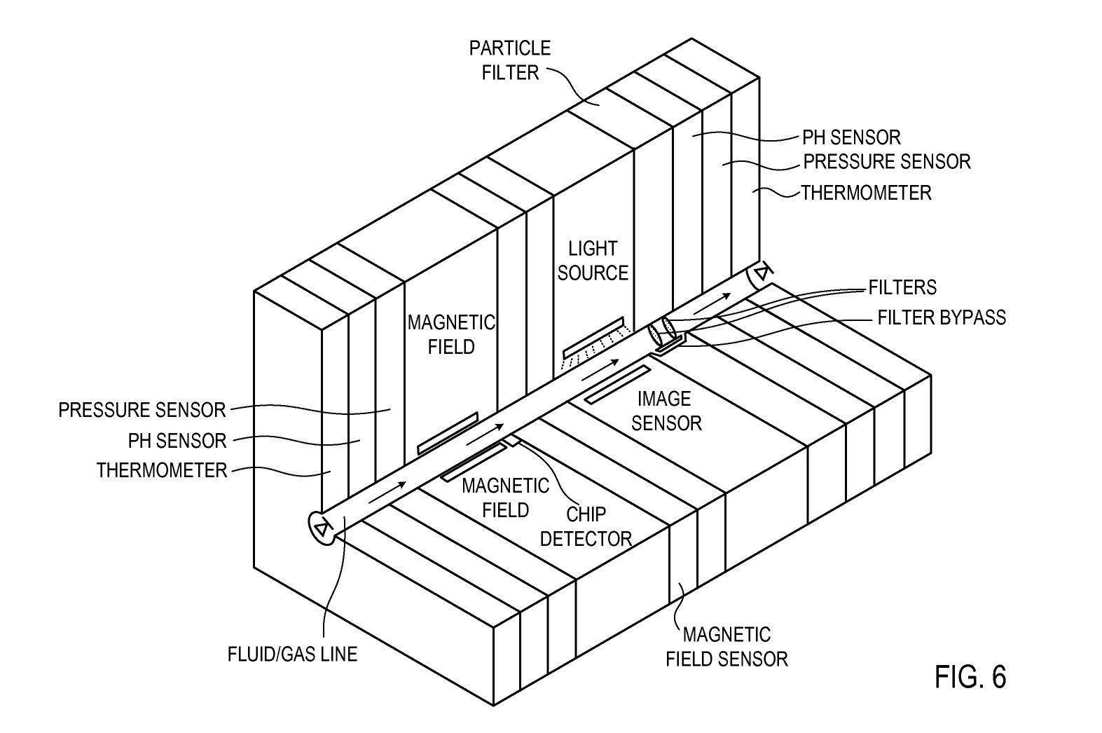

Reference is now made to FIGS. 1, 2 & 3A-3B which present exemplary illustrations of specific groups of VH sensors and their distribution. According to some embodiments, a VHMS system may include a set of VH sensors and/or groups of VH sensors, residing in and around the vehicle, for measuring parameters relating to the VH and operation of the vehicle. The set of VH sensors may include any sensor for measuring a parameter relating to the VH and/or operation of the vehicle, including but not limited to:
a. Acoustic sensors [marked 1 and 1A in FIG. 1] for detecting noises/sounds emitting from an engine of the vehicle and/or any other mechanical component of the vehicle (e.g. brakes, driveshaft, etc.). Acoustic sensors may detect noises resulting from friction, movement of vehicle components, etc. Based on the nature, frequency, location and amplitude of noises emitting from the engine and other mechanical components, a VHCPU may determine the condition of vehicle components and/or their interaction with other components;
   Acoustic sensors may be positioned adjacent to or near [an exemplary distribution of acoustic sensors is presented in FIG. 3B]: (1) the engine block—for detecting noises emitted from engine block components (e.g. pistons, rings, crank, etc); (2) the transmission and drive train—for detecting noises emitted from the transmission components (e.g. clutch, gear wheels, etc.) and drive train components (e.g. drive shaft and associated couplings); (3) wheels and/or axles—for detecting noises emitted from steering components and brake components (e.g. bearings, axles, brake pads/drums, etc); (4) the Alternator and other belt driven components (e.g. ac, timing belt, distributer, etc)—for detecting noises emitted from mechanical elements of belt driven components; (5) critical chassis sections—for detecting noises emitted as a result of any dislocation or looseness of chassis components; and/or (6) any other mechanical component of the vehicle. Furthermore, Acoustic sensors may be distributed in different areas of the vehicle (e.g. front, rear, left/right side, cabin, underside, etc.). Area Acoustic sensors may be used to isolate the source of a noise and/or to assist in determining whether a specific noise is being emitted by the vehicle or is coming from the surrounding environment. Area Acoustic sensors may also be used to verify/refute determinations and conclusions resulting from the measurements of other sensors. For example, if a suspected failure/deterioration of the front suspension is detected, the measurements of a front area Acoustic sensor may be used to determine if an actual fault/deterioration of the front suspension has occurred, by inspecting whether noises usually associated with faulty front suspension are present in the front area of the vehicle.
   Acoustic sensor measurements may be used to indicate any misalignment, degradation, fracture and/or other structural damage or deterioration of moving mechanical components of the vehicle. According to some embodiments, acoustic sensors may include analogical or digital filters in order to eliminate background noises and/or to determine directionality/source of a noise.
b. Optical/Flowing-substance sensors [marked 3 in FIG. 1] for measuring the transparency/contamination of liquids/gases used by the vehicle (e.g. engine oil, transmission oil, coolant) by means of imaging, magnetic measurements and tests, filtering and/or light penetration. According to some embodiments, an examined liquid may be subjected to a magnetic field prior to traveling through an optical sensor in order to extract/arrange Ferrite components.
   Reference is now made to FIG. 6 which is a schematic illustration of an exemplary flowing substance sensor, according to some embodiments of the present invention. According to some embodiments, flowing substance sensors may be through flow sensors, i.e. may be installed on a liquid or gas line such that the liquid or gas traveling through the native pipes of the vehicle passes through the sensor (marked fluid/gas line in the Fig). According to further embodiments, a flowing substance sensor may be installed in parallel to the native pipes of the vehicle, such that samples of the fluid/gas are examined by the sensor. The sensors for examining flowing substances may comprise:
   1. an initial area where entrance parameters (e.g. temperature, pressure, PH) are measured;
   2. A secondary area where the flowing substance is subjected to a magnetic field and which may further include a sensor for measuring changes in the magnetic field (changes in the magnetic field may be used to indicate fluctuations/changes in the amount/nature of metallic particles present in the flowing substance) and/or a chip detector may be installed upon the source of the magnetic field to determine the nature and concentration of particles in the flowing substance.
   3. Subsequent to the magnetic field, the flowing substance may pass through an optical sensor adapted to measure the transparency/contamination of the flowing substance by emitting light from one side and detecting the amplitude and frequencies of light arriving at the opposite side, i.e. a light source on one side of the flowing liquid and an image sensor on the other. Note, the magnetic field may arrange metallic particles within the flowing substance in a known or pre-designed pattern and may further be specifically configured to arrange the particles in such a pattern. Analysis of the image sensor measurements may consider this effect of the magnetic field;
   4. Particle filters may be placed within the fluid/gas line to filter particles out of the flowing substance. Accumulation of particles on the filters may be measured to determine contamination of the flowing substance and derivatively VH. According to further embodiments a filter bypass may be provided to allow the flowing substance to be controllably filtered. Accordingly, measurements with and without filtration may be performed and compared to determine particle concentration and derivatively VH; and
   5. an exit area where exit parameters (e.g. temperature, pressure, PH) are measured.
c. Vibration and/or piezoelectric sensors [marked 2 and 2A in FIG. 1] for measuring vibrations of mechanical components of the vehicle;
   Vibration sensors may be distributed throughout the vehicle (e.g. front, rear, cabin, underside, etc.) and/or adjacent to particular mechanical components (e.g. engine block, drive shaft, wheel base, etc.) [an exemplary distribution of vibration sensors is presented in FIG. 3A]. Changes in vibration amplitude and frequency may indicate any change in the motion or integrity of mechanical components of the vehicle. In the case of vibration sensors, as with acoustic sensors, analog and/or digital filters may be employed to eliminate background noise and to determine directionality and distance of sources of vibration. Further, as with Acoustic sensors, measurements of multiple vibration sensors may be cross referenced to validate/refute each other, isolate the source of a vibration and/or determine if a particular vibration is being caused by a component of the vehicle or from an outside source;
d. Radiation sensors for measuring electromagnetic radiation emitted from vehicle components;
e. Thermal sensors [marked 4 in FIG. 1] for measuring temperatures of one or more mechanical components and liquids of the vehicle. Deviations in operating temperature of vehicle components may indicate abnormal friction within the component or between two or more components. Abnormal friction may be caused by a fault in the component (e.g. worn down brake pads or a faulty piston ring) and/or by faults in lubrication or cooling within the vehicle. One or more Thermal sensors may also be positioned to measure the outside ambient temperature. Measurements of the outside ambient temperature may be factored into calculations regarding measurements of other sensors, as the outside temperature may affect the operating parameters of a vehicle. Further, measurements of outside temperature may be considered for profiling purposes as detailed below.
   According to further embodiments, thermal sensors be distributed in different areas of the vehicle (e.g. front, rear, left/right side, cabin, underside, etc.) to measure ambient temperatures in different areas of the vehicle;
f. Magnetic sensors for measuring magnetic fields created by electric currents and/or moving parts in a vehicle;
g. Energy sensors for measuring energy consumption/efficiency of the vehicle. For example, the electric energy drawn from a vehicle battery and/or engine, the fuel consumption in relation to mechanical energy generated by the engine, the energy created by the brakes, etc. By measuring the efficiency of energy conversion within vehicle systems an analysis of the integrity and proper operation of these systems can be performed. Furthermore, modern electric vehicles harvest electric energy from the braking mechanisms in the vehicle. Within such vehicles, a health of the braking systems can be indicated by the electric current they produce;
h. Environmental sensors [marked 5 in FIG. 1] for measuring relevant environmental parameters (e.g. outside temperature, humidity, air quality, etc). Measurements of the conditional environmental parameters may be factored into calculations regarding measurements of other sensors, as the environmental parameters may affect the operating parameters of a vehicle. Further, measurements of environmental parameters may be considered for profiling purposes, as detailed below;
i. Electric impedance/resistance sensors [marked 6 in FIG. 1] for measuring the electric impedance/resistance of particular components of a vehicle (which may indicate the thickness and/or operating temperature of a component). Accordingly, electric impedance sensors may be used to monitor the thickness of perishable components of a vehicle (e.g. brake pads)
Vehicle components with continuously degrading thickness may be monitored according to changes in electric resistance. By incorporating electric conductors inside the consumed material of a brake pad/brake rotor or clutch disc and continuously measuring an electrical current through it under a fixed voltage, thickness may be deduced. Once a component is installed in the car a calibration measurement may be performed. By continuously measuring the component's thickness several conclusions may be reached:
   1. thickness under a predefined threshold may indicate the need to inspect/replace a certain component.
   2. the wear pattern of a certain component in comparison to a predefined wear profile may indicate a need to inspect a car's subsystem long before reaching a dangerous threshold.
   3. comparing wear patterns of parts from similar batches may assist in identifying defective batches of parts.
   4. uneven wear of components may indicate problems in VH. For example, if a right brake pad wears down faster than the left this may indicate a fault in the left brake mechanism. Similarly, a sudden increase in the wear of a component may indicate a fault in VH;
j. Pressure sensors for measuring liquid or gas pressure within vehicle systems. Monitoring pressure inside closed systems such as brake fluid lines, oil lines etc. may be used to detect faults and low/high pressure.
Furthermore, by measuring pressure in several locations on a given system a fault may be isolated. Yet further, differences in pressure may in itself indicate a malfunction. For example when brake fluid pressure on a right side brake line is different from the pressure on the left side brake lines it may indicate a fault in one of the brake lines;
k. Air-borne Particle Sensors [marked 7 in FIG. 1] for detecting the presence and/or concentration of certain particles in the air associated with certain fluids and/or gases used in the vehicle may be distributed in the vehicle. Particle sensors may be situated in appropriate locations to detect leaks of fluids and/or gases in the vehicle's systems. Accordingly, data obtained from particle sensors may be used to detect leaks in the vehicle's systems based on the presence and/or added concentration of certain particles associated with certain fluids and/or gases used in the vehicle. Further, based on data from multiple particle sensors the location of the leak may be estimated. Suspected leaks may be verified/refuted based on data from an associated pressure sensor.
l. Distance sensors [marked 8 in FIG. 1] for measuring the distance between components of a vehicle (e.g. for measuring the distance between wheels of a vehicle). Distance measurements may be performed using laser TRx system, electrical resistance measurement and/or any other method.
Distance measurements may be used to indicate structural faults in a vehicle. For example, by measuring distance between an engine block and elements of the engine mount, degradation of engine supports may be indicated. Similarly, relative distances between different portions/sides of a structural element may indicate alignment/misalignment of the component. For example, by measuring the distance between the front wheels at different points misalignment of the wheels and/or steering mechanism may be indicated;
and/or
m. Accelerometers for measuring acceleration/deceleration of the vehicle and/or vehicle components in one or more directions. Accelerometers may be used to measure lateral and/or vertical acceleration of the vehicle and/or vehicle components as well as forward acceleration and deceleration. For example, an accelerometer may be positioned to measure the lateral movement of the vehicle during sharp turns (indicating the “slippage” of the vehicle), or vertical movement the vehicle while driving (indicating vehicle suspension operation). Obviously, a forward accelerometer may be used to indicate the health of acceleration and braking functions of a vehicle;
and/or
n. Any other vehicle health related sensor known today or to be devised in the future.

### Analysis and Profiling

Reference is now made to FIGS. 5A-5C. According to some embodiments, each VH sensor or group of VH sensors may measure and forward to the VHCPU one or more parameters relating to the operation and/or health of the vehicle and its components. According to further embodiments, a group of VH sensors, which may include a group of a particular type of VH sensors distributed in different locations throughout the vehicle, may measure and forward its measurements to a sensor group controller/processor, which may aggregate and/or analyze the measurements of the sensor/group and forward the results of its aggregation/analysis to the VHCPU. A VHCPU may, continuously, intermittently and/or upon instancement, assess a VH of the vehicle based on the received parameters. According to some embodiments, when assessing the VH of a vehicle, a VHCPU may determine a value or other indicator representing the overall health of the vehicle. Such a value or indicator may be based on a linear scale, a multidimensional vector or coordinate, a phase model and/or any other known evaluating system. Such a value may represent the overall health of the vehicle and may further represent certain aspects of the vehicle health. For example, the health indicator of a vehicle may be a multidimensional value in which the value of the x axis represents the overall health of the vehicle, the y axis the mechanical health of the vehicle and the z axis the electrical health of the vehicle.

In the event that the VHCPU determines, based on a given set of parameters received from the VH sensors and/or sensor group controllers/processors, that the VH of the vehicle is flawed, below a defined threshold and/or approaching such a condition, the VHCPU may: (1) issue a warning to a user of the vehicle, (2) initiate automatic corrective action if possible, (3) initiate automatic preventive action if possible (4) communicate the vehicle condition and/or sensed parameters to an external server/unit/VHMS, and/or (5) initiate emergency action (e.g. deactivate the vehicle or one of its components). The VHCPU may determine that the VH of the vehicle is flawed or below a defined threshold when a particular sensed parameter is below/above a defined threshold, and/or when a set of two or more parameters are each below/above a defined threshold, i.e. a VH may be assessed based on parameter thresholds on a parameter by parameter basis and/or based on thresholds defined for combinations of parameters. For example, a vehicle may be assessed as being in poor VH if the oil pressure is below x and/or if the oil pressure is below y while the operating temperature is above z. Furthermore, parameters detected by multiple sensors may be used to corroborate/refute each other. For example, in the event that parameters measured by an acoustic sensor adjacent to the engine block indicate a possible malfunction in a piston, parameters measured by a vibration sensor also adjacent to the engine block may be examined in order to corroborate or refute this conclusion. Yet further, parameters detected by multiple sensors of the same type may be used to determine the source of a measurement, to verify/refute the measurements performed by each other and/or to provide other data relating to the measured parameter. For example, if a knocking noise is sensed by an acoustic sensor near the driveshaft of the vehicle, the same knocking noise is sensed by an acoustic sensor in the rear of the vehicle and they both sense the same amplitude, it is likely the source of the noise is exterior to the vehicle, however if the noise is sensed considerably stronger by the acoustic sensor near the driveshaft, it is likely the noise is being emitted by the driveshaft. Similarly, if an abnormal vibration is detected in the vehicle, the VHCPU may check the current measurements of all the vibration sensors in the vehicle in order to determine the source of the vibration.

It should be understood that vehicle operating parameters are interrelated and therefore, many of the calculations and determinations described herein may involve the factoring of multiple parameters received from multiple sensors. The examples and descriptions presented herein are presented largely in relation to a particular parameter for the sake of simplicity, however, the description contained herein should be understood to equally refer to similar processes in relation to multiple parameters derived from multiple sensors.

According to further embodiments, a VHCPU may determine that the VH of the vehicle is flawed or below a defined threshold when a particular sensed parameter fluctuates in an abnormal fashion or otherwise behaves abnormally and/or when a set of particular parameters fluctuate in an abnormal fashion or otherwise behave abnormally.

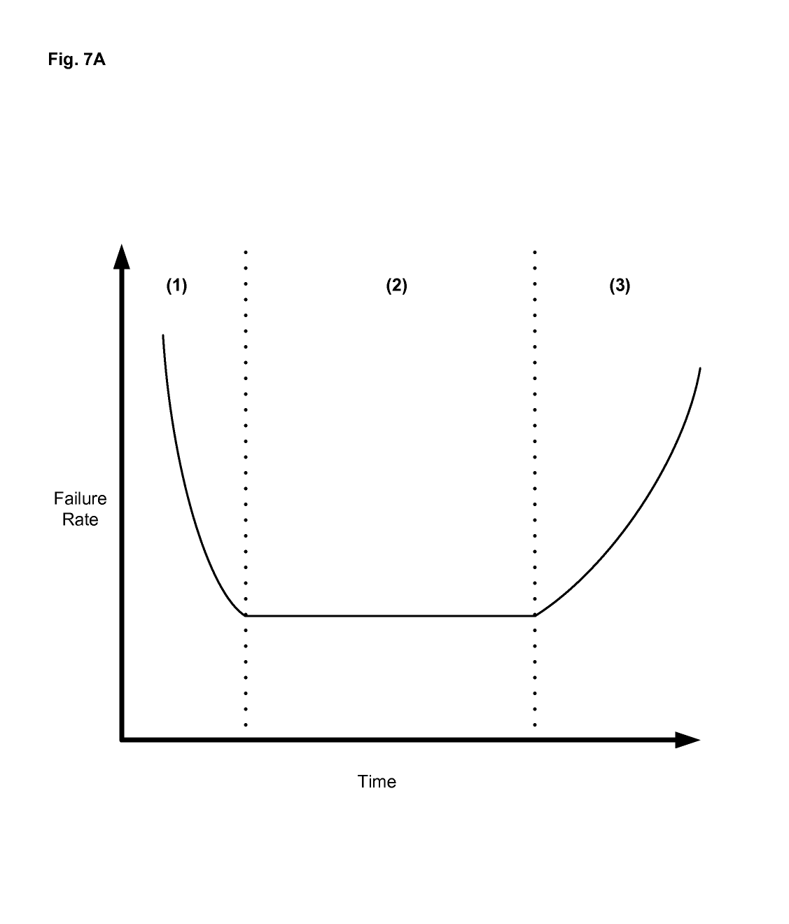

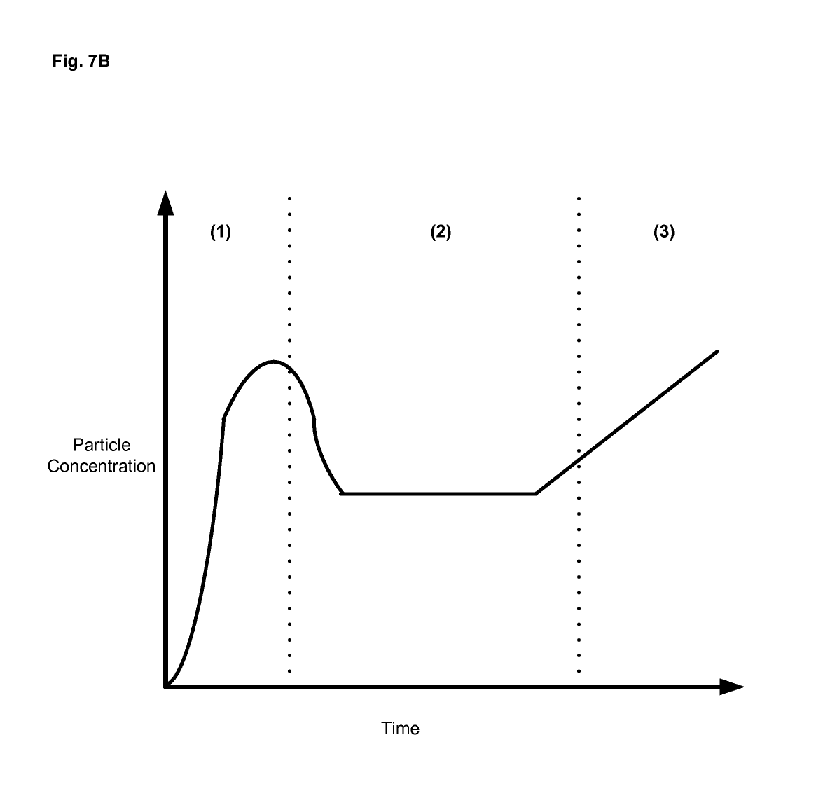

Similarly, the VHCPU may determine the VH of the vehicle is flawed when a particular sensed parameter and/or when a set of particular parameters indicates that a particular component has worn out beyond a desired threshold. Furthermore, a VHCPU may differentiate between different degrees of excess wear of a component and react accordingly. For example, a VHCPU may determine that the front brakes: (1) need replacement, (2) need urgent replacement, (3) need immediate replacement or (4) are no longer functional and the vehicle must be towed. It should be understood that thresholds as defined within this description refers to any model for acceptable/healthy levels of a particular parameter related to vehicle health and references to a parameter being below/above a particular threshold should be understood to include measurements of a particular parameter not coinciding with (i.e. deviating from) any model defining the acceptable/healthy levels/values for that parameter. An example of such a model is shown in FIG. 7A. FIG. 7A shows a typical “bathtub” type graph which is typical of many wear patterns of many vehicle components. As a result, many parameters measured by a VHMS will behave in correlation to such a pattern. Accordingly, similar graphs, relating to such parameters, may be pre-programmed into, developed by and/or received as updates by the VHCPU (an example of a correlated graph for Ferrographical parameters (particle concentrations in oil) may be seen in FIG. 7B). Stage (1) in the graphs represents the initial wear of the component which is usually relatively high until the component is fine-tuned to its new operating environment. Stage (2) in the graphs represents the healthy operating life of the component and stage (3) in the graphs represents the eventual deterioration of the component. Sensed parameter measurements may be compared to the relevant graphs to determine the condition of wear of the associated component and possibly to determine at any early stage the beginning of the deterioration of the component.

According to further embodiments, graphs of healthy/unhealthy VH parameter behavior, may be pre-programmed into a VHCPU. According to further embodiments, graphs of healthy/unhealthy VH parameter behavior may be developed and/or tuned by a VHCPU over time based on measured parameters of the particular vehicle it is associated with. According to yet further embodiments, graphs of healthy/unhealthy VH parameter behavior may be developed and/or tuned by other VHMS systems and/or a central server and received as updates by the VHCPU. Furthermore, such graphs may be correlated to and modified for specific profiles. For example, based on driving and/or environmental parameters (e.g. summer/winter graphs, highway/city graphs etc.).

According to some embodiments, a VHCPU may also determine a VH of a vehicle based on performance parameters, possibly in conjunction with environmental/operational parameters. For example, a VHCPU may determine a health of a vehicle based on the acceleration of the vehicle under different conditions (e.g. a vehicle which normally accelerates at 5 m/s² at full throttle on a level surface, may be determined to be unhealthy if it begins to accelerate at 3 m/s² at full throttle on a level surface).

According to further embodiments of the present invention, a VHCPU may collect data received from the VH sensors over time and may extrapolate from the collected data normal operating parameters relating to the typical operation of the specific vehicle it is associated with. The VHCPU may dynamically maintain a vehicle profile including “normal” operating parameters of the specific vehicle, which “normal” parameters may subsequently be employed as a comparison/base-line in order to assess the VH of the vehicle and/or to dynamically modify thresholds and operating parameters of the VHMS system. In other words, a VHCPU may develop a profile of normal operating parameters of the vehicle it is associated with. Subsequently, deviations from this profile may indicate faults or upcoming faults in the VH of the vehicle. According to further embodiments, a VHCPU may maintain multiple dynamic operating profiles for the vehicle it is associated with, each being associated with different environmental or driving profiles. For example, a VHCPU may maintain separate profiles for hot or cold weather, highway or city driving, different profiles for different drivers, etc. Similarly, profiles may be scaled, such that parameter thresholds are shifted based on circumstantial parameters, e.g. dependent on ambient temperature, driving speed, current gear engaged, latest brake replacement, etc. For example, vibration tolerance may be greater in first gear, or pressure thresholds may be higher in warmer weather, and so on.

According to further embodiments, a VHCPU may be functionally associated with a GPS device or other positioning device. A VHCPU and may record environmental conditions in specific areas or routes and modify its calculations accordingly. For example, a VHCPU may identify a rough section of road and accordingly modify its calculations relating to vibrations when the vehicle is driving over this section of road. A VHCPU may further factor topographical parameters associated with the location of the vehicle (e.g. steep uphill) and so on.

According to some embodiments, when a malfunction of a component of the vehicle occurs, measured operating parameters of the vehicle leading up to the malfunction may be analyzed in order to determine specific parameters which may have indicated, prior to the malfunction, that the malfunction is forthcoming. The results of this analysis may later be used as a comparison in order to determine the vehicles VH in the future and/or to dynamically modify thresholds and operating parameters of the VHMS system. For example, if it is found that prior to engine breakdown there were 10% fluctuations in oil pressure, future fluctuations in oil pressure of 10% or more may be interpreted to indicate upcoming engine failure. In other words, a particular vehicle's measurement history and “normal” measurements may be used as a comparison for determining the vehicles VH at a particular moment and/or to dynamically modify thresholds and operating parameters of the VHMS system. Furthermore, different parameters relating to a vehicle's VH may be compared and analyzed in conjunction in order to determine optimal and/or preferred operating parameters for the specific vehicle (e.g. an oil pressure which is correlated to the highest mileage per litre of fuel may be determined to be preferred to an oil pressure which produces a lower mileage per litre of fuel or an oil pressure which is correlated to the lowest vibrations in the engine may be preferred, etc.)

According to further embodiments, a VHCPU may factor into its calculations parameters relating to the operation of the vehicle, such as mileage, latest tune up, average speed and rpm, current speed and rpm, etc. According to further embodiments, a VHCPU may factor into its calculations environmental and circumstantial parameters relevant to the operation of the mechanical elements of the vehicle (e.g. outside temperature, humidity, air quality, etc.)

According to further embodiments, a VHCPU may determine if an assessed vehicle VH poses a safety risk and/or a degree of the risk and in the event that risk is determined, may: (1) issue a warning to a user of the vehicle, (2) initiate automatic corrective action if possible, (3) initiate automatic preventive action if possible (4) communicate the vehicle condition and/or sensed parameters to an external server/unit/VHMS, and/or (5) initiate emergency action (e.g. deactivate the vehicle or one of its components).

According to yet further embodiments, a VHCPU may maintain a gradiant profile for particular components of the vehicle in order to determine when service/replacement of the component is recommended/required. For example, a VHCPU may monitor the thickness of brake pads and notify a user of the vehicle when replacement of the brake pads is recommended. According to further embodiments, a sudden fluctuation in the wear of a component may indicate to the VHCPU a malfunction or fault in another component. For example, a sudden rise in the rate of deterioration of a brake pad may indicate a fault in the wheel or steering.

According to yet further embodiments of the present invention, data may be collected from multiple VHMS systems at a vehicle health monitoring system central server or servers. Such data may be sent to the central server or servers from the vehicles via any known communication technology, (e.g. via a cellular network). According to some embodiments, a VHCPU may include or be functionally associated with an appropriate communication module for communicating with one or more central servers. Such a central server or servers may analyze data received from multiple VHCPU's to determine typical operating parameters and/or profiles of vehicles, specific types of vehicles, specific models of vehicles, specific engine types, vehicles operating under particular conditions, vehicles of a particular age/mileage, etc. and update dynamic thresholds and operating parameters of relevant VHMS systems in light of the results of the analysis. Similarly, when a malfunction of a component of a vehicle having a VHMS system occurs, measured operating parameters of the vehicle leading up to the malfunction may be analyzed in order to determine specific parameters which may have indicated, prior to the malfunction, that the malfunction is forthcoming. The results of this analysis may later be used as a comparison in order to determine thresholds and operating parameters of other VHMS systems, possibly installed in a similar vehicle or a vehicle operating under similar conditions. In other words, data collected from one vehicle or many vehicles (i.e. statistical data) which experienced a failure may be used to determine parameters indicative of an upcoming problem in another vehicle. For example, if it is found that in 90% of cases, prior to engine breakdown in a Toyota, there were 10% fluctuations in oil pressure, whereas in 90% of cases, prior to engine breakdown in a Honda, there were 15% fluctuations in oil pressure all VHMS systems installed in Toyotas may determine future fluctuations in oil pressure of 10% or more as indicative of upcoming engine failure, while all VHMS systems installed in Hondas may determine only future fluctuations in oil pressure of 15% or more as indicative of upcoming engine failure. In other words, other vehicle's measurement histories and “normal” measurements may be used as a comparison for determining a particular vehicles mechanical condition at a particular moment. Furthermore, such data may be collected and used for other purposes, such as vehicle design, review of mechanics, etc.

According to some embodiments, a VHCPU may perform its assessments of vehicle VH based on one or more sets of desired operational parameters and associated thresholds for the vehicle pre-programmed into the VHMS system. According to further embodiments, initial desired parameters and associated thresholds may be defined by a calibration/normalization process including measurement of initial operating parameters to be used as a base line for future comparison. According to yet further embodiments, initial desired parameters and associated thresholds may be defined by a combination of pre-defined thresholds and a calibration process specific to the specific vehicle in question.

According to further embodiments, the desired operational parameters and associated thresholds for the vehicle may be dynamically modified over time based on the data monitored by the VHCPU and the associated analyses, parameters relating to the operation of the vehicle, such as mileage, latest tune up, average speed and rpm, etc, desired parameters determined by a centralized server or servers, which may be based on data collected from other vehicles, statistical analysis and/or updates provided by a proprietor of the system. Further, mechanical events (e.g. brake pad replacement) may be recorded in the VHCPU and the relevant thresholds and models modified accordingly.

According to some embodiments, a VHMS system may include a Human machine interface (possibly including a graphic user interface) for receiving input from a user of the vehicle and communicating to the user data relating to the VH of the vehicle and/or the VHMS system, e.g. for displaying to the user parameters relating to the VH of the vehicle, vehicle condition assessments, and/or vehicle mechanical condition warnings, for displaying to a user information relating to the mechanical condition of the vehicle (e.g. where to fill oil if it is determined that the vehicle oil pressure is low) and so on.

According to some embodiments, data mining of the raw data supplied by the sensors may be done in layers. For example, the measurements of each sensor or group of sensors may be analyzed separately, by a dedicated controller and/or by a module of the VHCPU. Parameters may be forwarded periodically and/or when an abnormal parameter is sensed. Accordingly, central processing may be done based on data preprocessed by the controllers and/or VHCPU modules such that only periodic and/or abnormal parameters are processed. Furthermore, certain parameters and/or parameter levels indicating urgent problems may receive priority in processing.

According to some embodiments, a VHMS may comprise a VH protocol for classification/report of fault conditions, sensed parameters and abnormalities/deviations. A VH protocol may comprise different types of detections. Each detection type may be associated with a specific group of monitored parameters. Examples of groups of detection types may include, (1) Specific fault detection, e.g. front brake pads to thin, right wheel misaligned, oil needs replacement, etc.; (2) System fault detection, e.g. suspension weak, cooling system flawed, etc; (3) General faults, such as low performance of engine, high electricity consumption; (4) General health condition, e.g. vehicle needs tune-up, vehicle is healthy, vehicle has mechanical fault, vehicle cannot proceed and needs to be towed, etc.; (5) VH related detection, e.g. intense knocks from rear part of the vehicle, abnormal vibration in engine, etc; (6) and so on.

According to further embodiments, a VH protocol may provide for classifying reports/messages based on urgency/priority, degree of deviation from the desired/acceptable parameter, recurrence/duration of deviation from the desired/acceptable parameter, number and/or identity of verifying sensors, and so on.

According to some embodiments, a VHMS may comprise separate processing modules for receiving and monitoring sensor measurements and for analyzing, profiling, communicating and recording the measurements. Accordingly, these processes may be performed in parallel/separately.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. A vehicle health monitoring system comprising,
two or more vehicle health sensors residing within a vehicle, each sensing one or more parameters associated with an operational condition of one or more components of the vehicle; and
a processing unit associated with said sensors, which processing unit determines an operational condition of the vehicle based on parameters detected by said sensors;
wherein said two or more sensors include at least one vibration sensor for sensing vibrations originating from mechanical components of the vehicle.

2. The system according to claim 1, wherein said two or more sensors include at least one acoustic sensor for sensing sounds originating from components of the vehicle.

3. The system according to claim 1, wherein determining an operational condition of the vehicle includes cross referencing measurements of at least two of said two or more sensors.

4. The system according to claim 1, wherein determining an operational condition of the vehicle includes comparing parameters currently being sensed by said vehicle health sensors to values determined based on parameters previously sensed by said vehicle health sensors.

5. The system according to claim 1, further comprising a communication module for communicating with a vehicle health monitoring system central server.

6. The system according to claim 5, wherein determining an operational condition of the vehicle includes comparing parameters currently sensed by vehicle health sensors to values received from said central server which received values were determined based on parameters previously sensed by vehicle health sensors installed in another vehicle.

7. The system according to claim 1, further comprising an environmental sensor, which environmental sensor senses parameters relating to the environmental conditions in the vicinity of the vehicle; and
wherein determining an operational condition of the vehicle includes factoring environmental conditions sensed by said environmental sensor.

8. A vehicle health monitoring system comprising,
two or more vehicle health sensors residing within a vehicle, each sensing one or more parameters associated with an operational condition of one or more components of the vehicle; and
a processing unit associated with said sensors for determining an operational condition of the vehicle based on parameters detected by said sensors;
wherein said two or more sensors include at least one optical fluid sensor, which optical fluid sensor includes a light source and a light sensor and determines a concentration of foreign particles within a fluid by measuring a transparency of the fluid.

9. The system according to claim 8, wherein said optical fluid sensor further comprises a magnetic field.

10. The system according to claim 8, wherein determining an operational condition of the vehicle includes cross referencing measurements of at least two of said two or more sensors.

11. The system according to claim 8, wherein determining an operational condition of the vehicle includes comparing parameters currently being sensed by said vehicle health sensors to values determined based on parameters previously sensed by said vehicle health sensors.

12. The system according to claim 8, further comprising a communication module for communicating with a vehicle health monitoring system central server.

13. The system according to claim 12, wherein determining an operational condition of the vehicle includes comparing parameters currently being sensed by said vehicle health sensors to values received from said central server, which received values were determined by said central server based on parameters previously sensed by vehicle health sensors installed in another vehicle.

14. The system according to claim 8, further comprising an environmental sensor, which environmental sensor senses parameters relating to the environmental conditions in the vicinity of the vehicle; and
wherein determining an operational condition of the vehicle includes factoring environmental conditions sensed by said environmental sensor.

15. A vehicle health monitoring system comprising,
two or more vehicle health sensors residing within a vehicle, each sensing one or more parameters associated with an operational condition of one or more components of the vehicle; and
a processing unit associated with said sensors, which processing unit:
(1) creates and maintains, based on parameters sensed by said vehicle health sensors, one or more vehicle operating profiles including normal operating parameters of the vehicle; and
(2) determines an operational condition of the vehicle is flawed when parameters detected by said sensors deviate beyond a threshold from the one or more profiles.

16. The system according to claim 15, wherein said processing unit also determines an operational condition of the vehicle is flawed when parameters detected by said sensors fluctuate abnormally.

17. The system according to claim 15, further comprising one or more sensor controllers, which sensor controllers receive from said sensors parameters sensed by said sensors, analyze the received parameters and forward to the processing unit the results of the analysis.

18. The system according to claim 15, further comprising an environmental sensor, which environmental sensor senses parameters relating to the environmental conditions in the vicinity of the vehicle.

19. The system according to claim 18, wherein said processing unit creates and maintains different operating profiles for different environmental conditions.

20. The system according to claim 15, wherein normal operating parameters of the vehicle are dependent upon a current speed of the vehicle.
